(19) United States
(12) Patent Application Publication
(10) Pub. No.: US 2025/0303434 A1
(43) Pub. Date: Oct. 2, 2025

(54) PROTECTIVE MEMBER FORMING APPARATUS AND METHOD FOR FORMING A PROTECTIVE MEMBER

(71) Applicant: DISCO CORPORATION, Tokyo (JP)

(72) Inventor: Daisuke HIROUCHI, Tokyo (JP)

(73) Assignee: DISCO CORPORATION, Tokyo (JP)

(21) Appl. No.: 19/082,724

(22) Filed: Mar. 18, 2025

(30) Foreign Application Priority Data
Mar. 28, 2024 (JP) 2024-053222
Dec. 10, 2024 (JP) 2024-215008

(51) Int. Cl. B05C 9/12

(52) U.S. Cl. CPC B05C 9/12

(57) ABSTRACT

A protective member forming apparatus includes a holder table configured to hold a sheet on a holder surface, a sheet feeder assembly configured to feed the holder table with the sheet, an attaching assembly configured to attach the sheet held on the holder table to a wafer, a light configured to irradiate the sheet held on the holder table, a camera configured to capture an image of the sheet, and a determining unit configured to determine whether air remains between the holder table and the sheet or not based on a difference in color tones, brightnesses, or colors in the image captured by the camera.

### CROSS REFERENCE TO RELATED APPLICATION

This application is based upon and claims the benefit of priority from the prior Japanese Patent Application No. 2024-053222 filed on Mar. 28, 2024 and the prior Japanese Patent Application No. 2024-215008 filed on Dec. 10, 2024; the entire contents of which are incorporated herein by reference.

### FIELD

The present disclosure relates to a protective member forming apparatus for forming a protective member that may protect a wafer and to a method for forming the protective member.

### BACKGROUND

For grinding both sides of a sliced wafer cut out from an ingot to produce a wafer having a desired thickness, a protective member may be formed on an entire surface on one side of the wafer. The wafer may be held on a chuck table of a grinding apparatus through the protective member on the one side, and a surface on the other side of the wafer may be ground with a grindstone.

A protective member forming apparatus for forming the protective member may feed a liquid resin to a sheet placed on a holder table and press and spread the liquid resin on the sheet to let the liquid resin cure on the sheet. In other words, the protective member may be composed of the sheet and a resin (the cured liquid resin).

When the protective member forming apparatus forms the protective member, as disclosed in Japanese Patent Laid-Open Publication No. 2017-174883, in order to avoid air bubbles from remaining between the holder table and the sheet, the sheet may be urged against the holder table with a roller, and thereby the air remaining between the sheet and the holder table may be removed.

However, even though the air may be generally removed with the roller, due to causes such as dust adhering to an upper surface of the holder table or a lower surface of the sheet, there may be cases that an air remainder (air bubble) stays between the holder table and the sheet. In a case where the protective member is formed in the state where the air bubbles remain between the holder table and the sheet, the protective member may partly be thinned at the position of the air remainder, resulting the thickness of the overall protective member to be uneven. When the wafer is ground in a grinding apparatus in the state where the wafer is supported through the protective member with the uneven thickness, a problem such that an in-plane thickness of the ground wafer may not be uneven may occur.

Therefore, a protective member forming apparatus and a method for forming a protective member have a problem to be solved, which is to form a protective member without forming an air remainder between a holder table and a sheet.

### SUMMARY

According to an aspect of the present disclosure, a protective member forming apparatus includes a holder table configured to hold a sheet on a holder surface, a sheet feeder assembly configured to feed the holder table with the sheet, an attaching assembly configured to attach the sheet held on the holder table to a wafer, a light configured to irradiate the sheet held on the holder table, a camera configured to capture an image of the sheet, and a determining unit configured to determine whether air remains between the holder table and the sheet or not based on a difference in color tones, brightnesses, or colors in the image captured by the camera.

According to an aspect of the present disclosure, a method for forming a protective member on one side of the wafer with the protective member forming apparatus includes a sheet-holding step including causing the sheet to be held on the holder table, an image-capturing step including capturing the image of the sheet by the camera, and a determining step including determining whether the air remains between the holder table and the sheet or not based on the difference in the color tones, the brightnesses, or the colors in the image captured in the image-capturing step. The method further includes, in a case where it is determined that the air remains between the holder table and the sheet in the determining step, a notifying step including notifying an operator of the air remaining between the holder table and the sheet. The method further includes, in a case where it is determined that no air remains between the holder table and the sheet in the determining step, a protective member forming step including forming of the protective member for protecting the one side of the wafer by attaching the sheet to the wafer.

Optionally, the protective member forming step may include an expanding step including feeding a liquid resin to a position between the sheet and the wafer and expanding the liquid resin over an entire surface of the wafer on the one side, and a curing step including curing the liquid resin expanded in the expanding step. The sheet may be attached to the wafer through a resin which is the liquid resin being cured.

According to embodiments of the present disclosure, by confirming that no air remains between the holder table and the sheet based on the image captured by the camera, the protective member in an even thickness where no air remainder is left between the holder table and the sheet may be formed.

### BRIEF DESCRIPTION OF THE DRAWINGS

FIG. 1 is a perspective view of a protective member forming apparatus.

FIG. 2 is a cross-sectional view of the protective member forming apparatus performing an image-capturing step and a determining step.

FIG. 3 is an illustrative view of captured images to be referred to in the determining step.

FIG. 4 is a cross-sectional view illustrating an expanding step.

FIG. 5 is a cross-sectional view illustrating the expanding step.

FIG. 6 is a cross-sectional view illustrating a curing step.

### DESCRIPTION OF EMBODIMENTS

Hereinbelow, a protective member forming apparatus and a method for forming a protective member will be described below with reference to the accompanying drawings. An X-axis direction, a Y-axis direction, and a Z-axis direction shown in the drawings are orthogonal to one another. The X-axis direction and the Y-axis direction are horizontal directions. The Z-axis direction is a vertical direction, where a +Z direction side is an upper side, and a-Z direction side is a lower side.

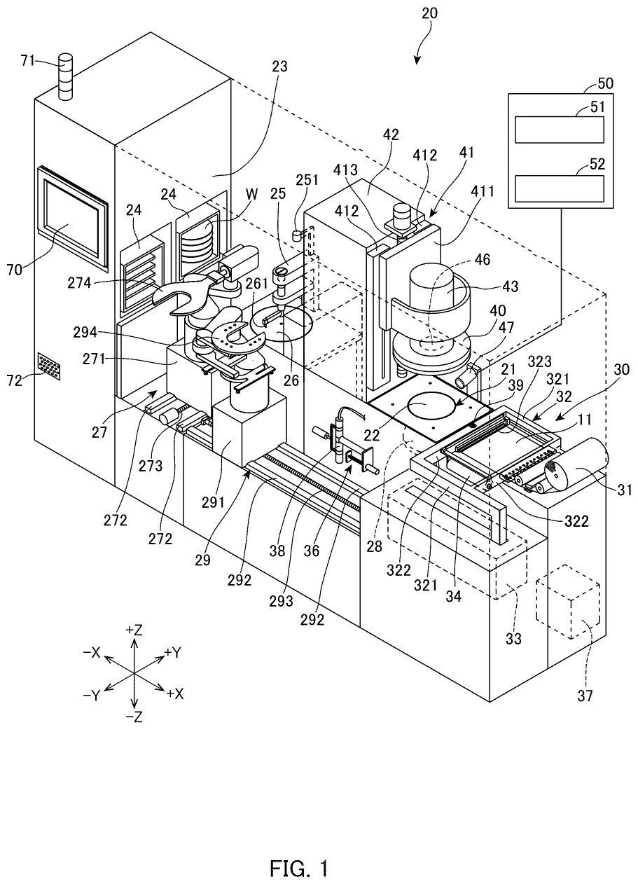

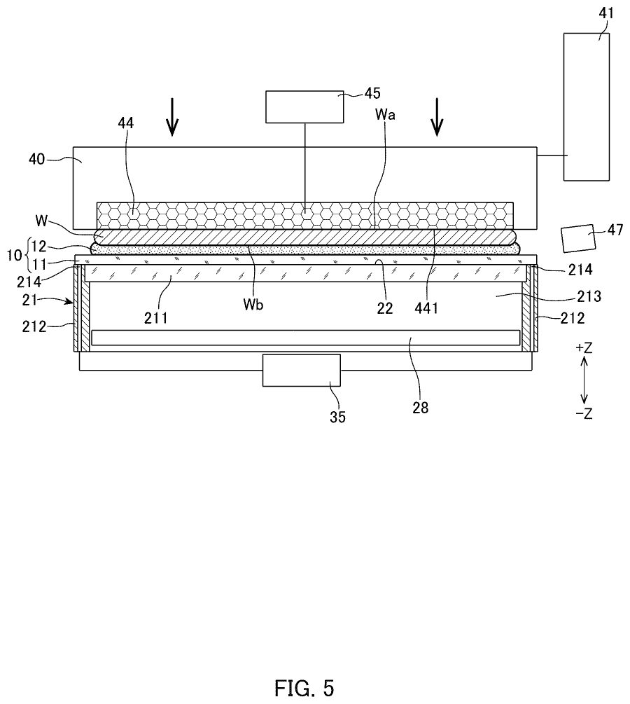

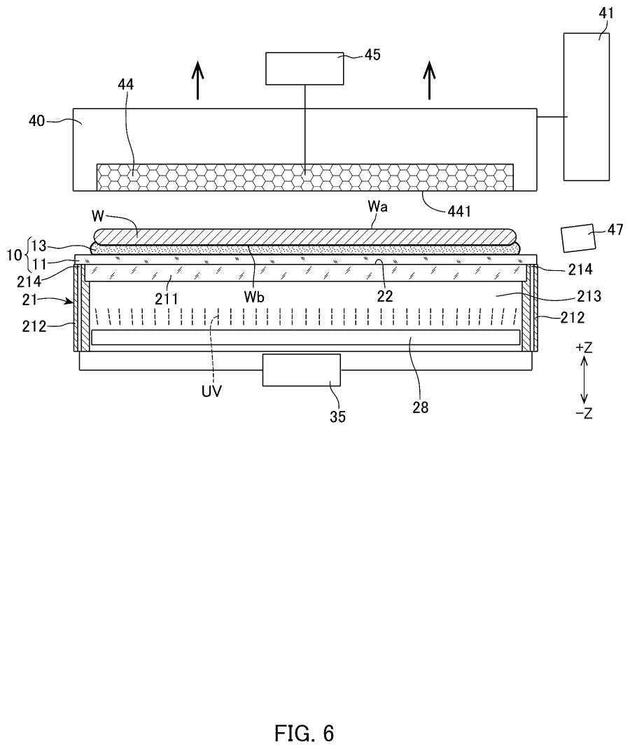

A protective member forming apparatus 20 shown in FIG. 1 is an apparatus for forming a protective member 10 (see FIGS. 5 and 6) to cover an entire surface on one side of a wafer W. Among surfaces of the wafer W, a surface on one side facing upward and another surface on the other side facing downward, when the wafer W is being processed in the protective member forming apparatus 1, will be referred to as an upper surface Wa and a lower surface Wb, respectively. The wafer W may be, for example, a disk-shaped sliced wafer cut out from a cylindrical ingot of, for example, silicon. The wafer W having the protective member 10 formed thereon in the protective member forming apparatus 20 may be conveyed to a grinding apparatus, which is not shown, to be held on a holder surface of a chuck table provided to the grinding apparatus, and the upper surface Wa thereof may be ground with a grindstone. It may be noted that the wafer W may not necessarily be limited to the sliced wafer, on which devices are not yet formed, but may be a device wafer, on which devices are already formed.

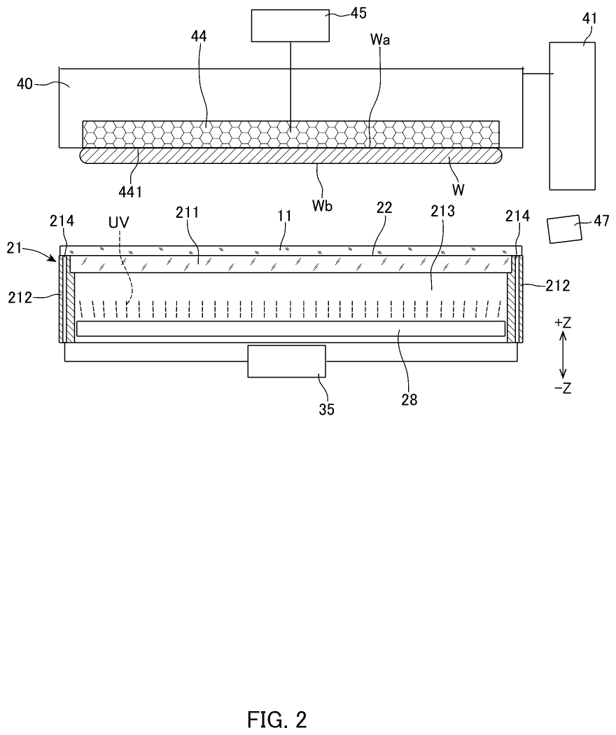

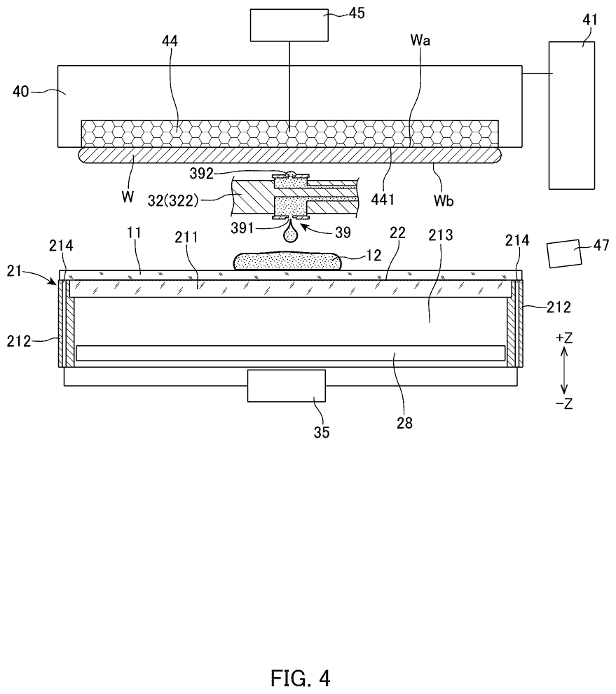

For forming the protective member 10 in the protective member forming apparatus 20, a sheet 11 is held on a holder surface 22 of a holder table 21 (see FIG. 2), a liquid resin 12 is fed to the sheet 11 from an upper side of the holder table 21 (see FIG. 4), a wafer holder table 40 holding the wafer W by the upper surface Wa urges the lower surface Wb of the wafer W the holder table 21 from above to spread the liquid resin 12 (see FIG. 5). By leaving the liquid resin 12 spread on the sheet 11 to cure, the protective member 10 composed of the sheet 11 and the cured resin 13 is formed (see FIG. 6).

The sheet 11 is made of a translucent material. The sheet 11 may be a sheet made of, for example, polyethylene terephthalate. Optionally, the sheet 11 may be made of a material other than polyethylene terephthalate.

The liquid resin 12 has a property to cure in reaction to a predetermined external stimulus. In the present embodiment, the liquid resin 12 is a UV-curable liquid resin. The liquid resin 12 pressed against and spread to cover the entire lower surface Wb of the wafer W (see FIG. 5) may be exposed to ultraviolet rays, and thereby the liquid resin 12 may be cured into resin 13 (see FIG. 6). The external stimulus that may cure the liquid resin 12 may not necessarily be limited to irradiation with ultraviolet rays but may be, for example, temperature changes such as heating or cooling, or irradiation with light other than ultraviolet rays having a different wavelength.

As shown in FIG. 1, the protective member forming apparatus 20 has a cassette storage 23 at an area on an end thereof on the +X direction side. In the cassette storage 23, two storage spaces that are open toward the +X direction side are formed at different positions in Y-axis direction. In one of the two storage spaces, a cassette 24 containing wafers W, on which the protective members 10 are not yet formed, is stored for loading. In the other of the two storage spaces, a cassette 24 containing wafers W, on which the protective members 10 are already formed, is stored for unloading. Each cassette 24 may contain a plurality of wafers W.

At a position on the +X direction side with respect to the cassette storage 23, a temporary placement table 25 and a sheet cutting table 26 are arranged. The temporary placement table 25 is located at an upper position, and the sheet cutting table 26 is located at a lower position. The temporary placement table 25 is provided with a wafer detector device 251, which may detect a central position and an orientation of the wafer W before the protective member 10 is formed thereon. The sheet cutting table 26 is provided with a sheet cutter 261 that may cut the sheet 11 adhered to the wafer W along an outline of the wafer W.

At a position between the cassette storage 23 and the temporary placement table 25 or the sheet cutting table 26 in the X-axis direction, a first conveyer assembly 27 is provided. The first conveyer assembly 27 supports a pedestal 271 movably along a pair of guide rails 272, which extend in the Y-axis direction. The first conveyer assembly 27 may move the pedestal 271 in the Y-axis direction by driving a motor to rotate a ball screw 273, which extends in the Y-axis direction. On the pedestal 271, a robot hand 274 is supported. The first conveyer assembly 27 may, by moving the pedestal 271 in the Y-axis direction and operating the robot hand 274, convey the wafer W between the cassette 24 in the cassette storage 23 and the temporary placement table 25, the sheet cutting table 26.

At a position apart from the temporary placement table 25 and the sheet cutting table 26 toward the +X direction side, a holder table 21 is provided. As shown in FIGS. 2, 4, 5, and 6, the holder table 21 includes a holder plate 211 formed of a translucent material such as quartz glass and a frame member 212 in a cylindrical form to support a circumferential edge of the holder plate 211. An upper surface of the holder plate 211 is flat and forms a holder surface 22, on which the sheet 11 may be placed. Inside the frame member 212, an inner space 213 being a hollow space is formed, and the holder plate 211 covers the inner space 213 from above.

On a bottom of the inner space 213, a light 28 is provided. The light 28 is a light source that may emit ultraviolet rays UV (see FIGS. 2 and 6) upward, where the holder plate 211 is located. The ultraviolet rays UV from the light 28 may be emitted at the liquid resin 12 on the sheet 11 through the holder plate 211 and the sheet 11 that are translucent and may cure the liquid resin 12. The ultraviolet rays UV emitted from the light 28 may have a wavelength of approximately 200 nm-400 nm.

As shown in FIG. 1, a second conveyer assembly 29 to convey the wafer W is located at a position on the −Y direction side with respect to the holder table 21, the temporary placement table 25, and the sheet cutting table 26. The second conveyer assembly 29 supports a pedestal 291 movably along a pair of guide rails 292, which extend in the X-axis direction. The second conveyer assembly 29 may move the pedestal 291 in the X-axis direction by driving a motor to rotate a ball screw 293, which extends in the X-axis direction. On the pedestal 291, a robot hand 294 is supported. The second conveyer assembly 29 may, by moving the pedestal 291 in the X-axis direction and operating the robot hand 294, convey the wafer W between the temporary placement table 25, the sheet cutting table 26 and the holder table 21.

As shown in FIG. 1, the protective member forming apparatus 20 includes a sheet feeder assembly 30 that may feed the holder table 21 with the sheet 11. The sheet feeder assembly 30 includes a sheet feeder device 31, which supports the sheet 11 in a rolled form, and a sheet conveyer arm 32, which may draw the sheet 11 out from the sheet feeder device 31. The sheet conveyer arm 32 is in a rectangular-framed structure having a pair of X-axis extending portions 321, which extend in parallel to each other in the X-axis direction, and a pair of Y-axis extending portions 322, which extend in parallel to each other in the Y-axis direction. To one of the Y-axis extending portions 322 located on the −X direction side, a sheet gripper device 323 to grip an end of the sheet 11 on the −X direction side is provided.

The sheet conveyer arm 32 may be moved in the X-axis direction by a conveyer arm driving assembly 33. The conveyer arm driving assembly 33 may consist of, for example, a ball screw assembly and an air cylinder. The conveyer arm driving assembly 33 may draw the sheet 11 out from the sheet feeder device 31 by moving the sheet conveyer arm 32 toward the −X direction side with the sheet 11 being gripped by the sheet gripper device 323.

To the sheet conveyer arm 32, at a position between the pair of Y-axis extending portions 322, a sheet pressing roller 34 which may rotate on an axis extending in the X-axis direction is provided. The sheet pressing roller 34 is movably supported and may be moved in the Y-axis direction along the Y-axis extending portions 322 by a force from a driving source such as a motor, which is not shown. As the sheet conveyer arm 32 is moved toward the −X direction side, and the sheet 11 is pulled to a position to cover the holder surface 22 of the holder table 21, the sheet pressing roller 34 may be moved in the Y-axis direction. The sheet pressing roller 34 may roll, while urging the sheet 11 having been pulled out from the roll from above against the holder surface 22 with a predetermined intensity, to traverse the sheet 11 in the Y-axis direction widthwise. By this behavior of the sheet pressing roller 34, air may be pushed out from the position between the sheet 11 and the holder surface 22, and the sheet 11 may fit tightly to the holder surface 22.

The sheet 11 is, in the state being set on the holder surface 22, may be cut with a sheet cutter provided to the sheet feeder assembly 30. The sheet cutter may move in the Y-axis direction and cut the sheet 11 held on the holder table 21, thereby forming an end of the sheet 11 on the +X direction side.

As shown in FIGS. 2, 4, 5, and 6, the holder table 21 has a plurality of suction holes 214, which are formed to open on an upper surface of the frame member 212. The suction holes 214 are connected to a suction source 35. As the suction source 35 is driven, the air may be suctioned through the suction holes 214, and a negative pressure may be exerted, thereby suctioning and holding the sheet 11 against the holder surface 22 of the holder table 21.

The protective member forming apparatus 20 is provided with a liquid resin feeder assembly 36, which may feed the liquid resin 12 to the sheet 11 held on the holder table 21. The liquid resin feeder assembly 36 includes a tank 37 located inside the protective member forming apparatus 20, a dispenser 38 connected to the tank 37, and a liquid resin feeder nozzle 39 connected with a feeder tube extending from the dispenser 38. The liquid resin 12 stored in the tank 37 may be forwarded to the liquid resin feeder nozzle 39 by an operation with the dispenser 38.

As shown in FIGS. 1 and 4, the liquid resin feeder nozzle 39 is provided to the sheet conveyer arm 32 on one of the Y-axis extending portions 322 located on the −X direction side and includes a lower nozzle 391 orienting downward and an upper nozzle 392 orienting upward. The liquid resin feeder assembly 36 may control feeding of the liquid resin 12 from the lower nozzle 391 and feeding of the liquid resin 12 from the upper nozzle 392 separately. By the operation with the dispenser 38, amounts of the liquid resin 12 to be fed from the lower nozzle 391 and the upper nozzle 392 may be controlled respectively.

The liquid resin 12 discharged from the lower nozzle 391 may drip onto the sheet 11 held on the holder table 21. The liquid resin 12 discharged from the upper nozzle 392 may adhere to the lower surface Wb of the wafer W held on the wafer holder table 40, which will be described further below. Optionally, the liquid resin feeder nozzle 39 may not be equipped with the upper nozzle 392 but may be equipped solely with the lower nozzle 391. In other words, as long as the sheet 11 is fed with the liquid resin 12, adherence of the liquid resin 12 to the lower surface Wb of the wafer W is not necessary at the stage of feeding the sheet 11 with the liquid resin 12.

The wafer holder table 40 is located above the holder table 21. The wafer holder table 40 is supported by a column 42, which is located on the-X direction side of the holder table 21, through a lift/lower assembly 41 movably in the Z-axis direction. The lift/lower assembly 41 supports a lift/lower table 411 movably along a pair of guide rails 412, which extend in the Z-axis direction. The lift/lower assembly 41 may be operated to rotate a ball screw 413, which extends in the Z-axis direction, with a driving force from a motor, thereby moving the lift/lower table 411 in the Z-axis direction. The wafer holder table 40 and the lift/lower assembly 41 compose an attaching assembly, which may attach the sheet 11 held on the holder table 21 to the wafer W via the liquid resin 12.

The wafer holder table 40 is in a shape of a disk and is supported by a lower end of a supporting member 43, which is movable along with the lift/lower table 411 in the Z-axis direction. As the lift/lower assembly 41 is operated to move the lift/lower table 411, the wafer holder table 40 may move in the Z-axis direction. As shown in FIGS. 2, 4, 5, and 6, on a lower side of the wafer holder table 40, a suction sheet 44 being a disk-shaped porous member is provided. A lower surface of the suction sheet 44 forms a wafer holder surface 441, on which the upper surface Wa of the wafer W may be suctioned and held. The suction sheet 44 is connected to a suction source 45. As the suction source 45 is driven, the air may be suctioned through the suction sheet 44, and a negative pressure may be exerted, thereby suctioning and holding the upper surface Wa of the wafer W against the wafer holder surface 441.

Between the wafer holder table 40 and the supporting member 43, a load sensor 46 to detect a load acting on the wafer holder table 40 in the Z-axis direction is provided.

A camera 47 is located at a sideward position with respect to the holder table 21. The camera 47 is located to be higher than the holder surface 22 of the holder table 21 and may capture an image of the sheet 11 held on the holder surface 22 from a position in an oblique direction. In particular, the camera 47 is set in an arrangement such that an optical axis of an optical system thereof skews by a predetermined angle with respect to a direction (horizontal direction) parallel to the holder surface 22 of the holder table 21, and the camera 47 may capture an image of the sheet 11 in a look-down view from an obliquely upper position. The camera 47 has an image-capturing device, and as the image of the sheet 11 entering through the optical system is formed on a light-receivable surface of the image-capturing device, the image-capturing device may convert the image photoelectrically and generate image signals on a pixel basis.

The camera 47 to capture the image of the sheet 11 from the position in the oblique direction is located on a radially outside of the holder table 21. Therefore, the camera 47 may capture the image of the sheet 11 at a desired timing without affecting behaviors of the other devices for forming the protective member 10, such as a behavior of the sheet conveyer arm 32 in the sheet feeder assembly 30 and a behavior of the wafer holder table 40 moved vertically by the lift/lower assembly 41. Moreover, the camera 47 may capture the image of the sheet 11 without moving to a position straight above the holder table 21; therefore, capturing of the image does not require a time to wait for the camera 47 to be moved, and the protective member 10 may be formed efficiently.

The optical system of the camera 47 has an angle of view to capture the image of the entire surface of the sheet 11 held on the holder surface 22 of the holder table 21. Compared to an arrangement where a camera captures an image of the sheet 11 from a position to directly face the sheet 11 in the Z-axis direction (straight above), the camera 47 capturing the image of the sheet 11 from the position in the oblique direction may capture the image that covers the entire surface of the sheet 11 with the optical system having a relatively narrow angle of view; therefore, rather than using an ultrawide-angle lens (fisheye lens), an optical system that is more versatile and readily available may be used. Moreover, compared to a camera that captures an image of the sheet 11 from a straight sideward position, the camera 47 that captures the image of the sheet 11 from the position in the oblique direction may provide an image containing a large amount of information, enabling highly accurate determinations regarding where and how much underneath the sheet 11 the air remains. Optionally, however, the image of the sheet 11 may be captured from a straight sideward position.

The protective member forming apparatus 20 is controlled overall by a controller 50 (see FIG. 1). The controller 50 may be composed of, for example, a processor to execute various processes and a storage (memory) storing various parameters and controlling programs. The storage of the controller 50 stores a program for implementing the method for forming a protective member, which will be described further below, as a controlling program to control the protective member forming apparatus 20. The program includes an algorithm for determining whether the air (air bubbles) remains or not based on the image captured by the camera 47.

The controller 50 has an image processing unit 51 and a determining unit 52 as function blocks. The image processing unit 51 may receive image signals from the image-capturing device in the camera 47, process the received imaging signals, and generate a captured image in a predetermined image format. The determining unit 52 may determine whether the air remains between the holder table 21 and the sheet 11 or not based on the captured image generated by the image processing unit 51. The functions of the image processing unit 51 and the determining unit 52 are implemented by operations with devices including the processor and the memory that compose the controller 50, but it does not necessarily mean that the image processing unit 51 and the determining unit 52 are each composed of an independent single piece of electric device. Moreover, FIG. 1 illustrates the sole connection between the camera 47 and the controller 50; however, the controller 50 is connected with other devices in the protective member forming apparatus 20 than the camera 47 and is enabled to exchange signals with them.

Next, forming of the protective member 10 with the protective member forming apparatus 20 described above will be described. For the operation of each component in the protective member forming apparatus 20 described below, when no explicit entity is specified as a subject to control the operation, it is assumed that the operation is performed under the control of the controller 50.

### Sheet-Feeding Step

In the sheet-feeding step, the sheet feeder assembly 30 is operated to feed the holder table 21 with the sheet 11. The sheet gripper device 323 of the sheet conveyer arm 32 is operated to grip the end of the sheet 11, the conveyer arm driving assembly 33 is operated to move the sheet conveyer arm 32 toward the −X direction side, and the sheet 11 is drawn out from the sheet feeder device 31. As the sheet 11 is drawn to the position to cover the holder surface 22 of the holder table 21, the conveyer arm driving assembly 33 is operated to stop moving the sheet conveyer arm 32.

### Sheet-Holding Step

Next, a sheet-holding step, in which the sheet 11 is held on the holder table 21, is performed. In the sheet-holding step, the sheet pressing roller 34 is moved in the Y-axis direction on the sheet 11 having been drawn, causing the sheet pressing roller 34 to urge the sheet 11 against the holder table 21, and removing the air from the position between the sheet 11 and the holder surface 22. Moreover, the suction source 35 is operated to suction the air through the suction holes 214 so that the sheet 11 may be suctioned and held against the holder surface 22 of the holder table 21. By these operations, the sheet 11 is held on the holder table 21. Thereafter, with the sheet cutter in the sheet feeder assembly 30, the end of the sheet held on the holder table 21 on the +X direction side is cut off.

In the sheet-holding step, in the state where the sheet 11 is held on the holder table 21 correctly, the air should be removed from the position between the sheet 11 and the holder surface 22 by the operation with the sheet pressing roller 34, and the entire lower surface of the sheet 11 should fit tightly to the holder surface 22 of the holder table 21. However, due to factors such as dust adhered to the holder surface 22 of the holder table 21 or the lower surface of the sheet 11 when the holder table 21 holds the sheet 11 thereon, there may be a case that the air remains between the holder surface 22 and the sheet 11 even after the sheet 11 underwent the pressure of the sheet pressing roller 34.

The protective member 10, formed under the condition where the air remains between the holder surface 22 of the holder table 21 and the sheet 11, may be formed to be thinner at the positions of the remaining air, causing unevenness in thickness of the protective member 10. Grinding of the wafer W while the thickness of the protective member 10 is uneven may cause a problem such that the in-plane thickness of the ground wafer W may not be even. Therefore, with the protective member forming apparatus 20, in order to form the protective member 10 without leaving the air between the holder table 21 and the sheet 11, an image-capturing step, in which the camera 47 captures the image of the sheet 11, and a determining step, in which whether the air remains between the holder table 21 and the sheet 11 or not is determined based on the image captured in the image-capturing step, are performed. The image-capturing step and the determining step are performed after the holder table 21 is fed with the sheet 11 in the sheet-feeding step and the sheet 11 is held on the holder surface 22 in the sheet-holding step, and before the sheet 11 is fed with the liquid resin 12 and the protective member 10 is formed.

### Image-Capturing Step

FIG. 2 illustrates the image-capturing step being performed to capture the image of the sheet 11 with the camera 47 and the determining step being performed to determine whether the air remains between the holder table 21 and the sheet 11. In the image-capturing step, the light 28 arranged in the inner space 213 inside the holder table 21 emits the ultraviolet rays UV at the holder plate 211 and the sheet 11 located above. In this state, the camera 47 captures the image of the sheet 11 on the holder table 21, and the captured image is generated through the image processing in the image processing unit 51. Both the holder plate 211 and the sheet 11 are made of the translucent material; therefore, in the state where the holder plate 211 and the sheet 11 are irradiated with the ultraviolet rays UV emitted from the light 28 from below, when the camera 47 captures the image of the sheet 11 from obliquely above, the captured image with a predetermined brightness and a color tone may be obtained. It may be noted that, at this point of the image-capturing step, the sheet 11 is not yet fed with the UV-curable liquid resin 12; therefore, emitting the ultraviolet rays UV from the light 28 does not cause curing of the liquid resin 12.

### Determining Step

In the case where the air remains between the holder table 21 and the sheet 11, in the captured image, a difference such as, for example, difference in color tones, brightnesses, or colors, may appear between a region containing no air and a region containing the air. Therefore, in the determining step, with use of the color tones, brightnesses, and/or the information concerning the colors based on the image captured by the camera 47, the determining unit 52 in the controller 50 determines whether or not the air remains between the holder table 21 and the sheet 11. Optionally, unlike FIG. 2, during the determining step, the light 28 may not be emitting the ultraviolet rays UV.

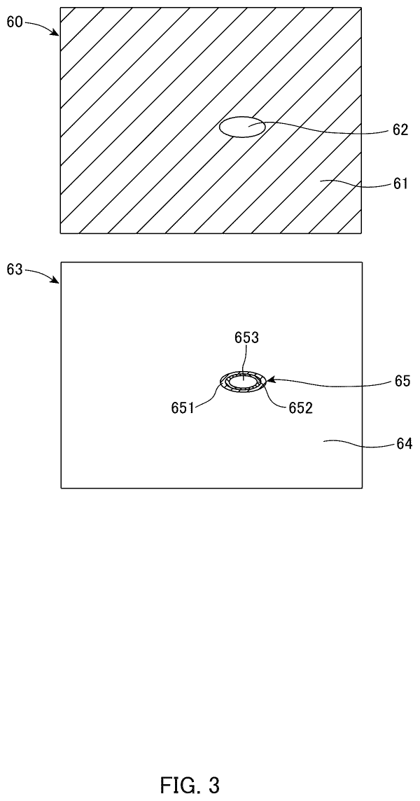

FIG. 3 illustrates a captured image 60 and a captured image 63 in the case where the air remains between the holder table 21 and the sheet 11. Color tone of the image captured by the camera 47 and appearance of the region containing the air in the captured image may differ depending on conditions including, for example, arrangement of the light source and a wavelength of the light emitted from the light source. The controller 50 stores a controlling program that enables the determining unit 52 to determine presence of the air in the captured image according to these conditions.

The captured image 60 in FIG. 3 illustrates the image of the sheet 11 on the holder table 21, which is irradiated from below with the ultraviolet rays UV emitted from the light 28, captured by the camera 47 from the position in the oblique direction. In the captured image 60, a first region 61 corresponds to the region where substantially no air remains and the sheet 11 fits tightly to holder table 21, and a second region 62 corresponds to the region where the air remains between the holder surface 22 and the sheet 11. In the captured image 60, for example, the first region 61 may appear in a dark blue color, and the second region 62 may appear in an oval shape and in a light blue color. As such, by capturing the image of the sheet 11 from the position in the oblique direction, the captured image, in which the region containing no air and the region containing the air are distinguished by the brightness (different color densities), may be obtained.

The determining unit 52 may determine, based on the information contained in the first region 61 and the second region 62 where the brightnesses are different, the air remains between the holder table 21 and the sheet 11 in the region corresponding to the second region 62, where the brightness is higher. The determining unit 52 may, for example, set a threshold value of brightness as a criterion for determination and determine that a region of the captured image having a brightness higher than the threshold value (higher in brightness) contains the air. When substantially no air remains between the holder table 21 and the sheet 11, the entire captured image 60 is categorized as the first region 61, where the brightness is lower than or equal to the threshold value; therefore, the determining unit 52 may determine that no air remains between the entire sheet 11 and the holder table 21.

The light 28 is usable for curing the liquid resin 12 being UV-curable resin in a curing step, which will be described further below. As such, the light 28 to be used for curing the liquid resin 12 in the curing step is also used as the light source for capturing the image in the image-capturing step, and thereby a number of items to compose the protective member forming apparatus 20 may be reduced, and the configuration of the protective member forming apparatus 20 may be simplified.

The light to be used as the light source for capturing the image in the image-capturing step is not necessarily limited to the light 28 located inside the holder table 21 for emitting the ultraviolet rays UV from below. For example, light from an interior lighting device (ambient light) to illuminate a clean room in which the protective member forming apparatus 20 is installed may be used as the light source, and the camera 47 may capture the image using the light reaching from the outside of the holder table 21 in the image-capturing step. Many of such interior lighting devices may emit white light containing entire wavelengths of visible light.

The captured image 63 in FIG. 3 illustrates an image of the sheet 11 on the holder table 21, which is irradiated with the white light emitted from the interior lighting device (not shown) arranged outside the holder table 21, captured by the camera 47 from the position in the oblique direction. In the captured image 63, a first region 64 corresponds to the region where substantially no air remains and the sheet 11 fits tightly to the holder table 21, and a second region 65 corresponds to the region where the air remains between the holder surface 22 and the sheet 11. In the captured image 63, for example, the first region 64 may appear transparent. The second region 65 is composed of a plurality of different-colored regions with contours, including an outer peripheral region 651, which may appear in a shape of an oval ring in a blue color, an intermediate region 652, which may appear in a shape of an oval ring in a green color, and an inner region 653, which may appear in an oval shape and transparent, for example.

The determining unit 52 may determine the air remains in the region corresponding to the second region 65 based on, for example, a difference in colors (difference in color tones) between the first region 64 and the second region 65 in the captured image 63 and information concerning a pattern of the contours formed with the outer peripheral region 651, the intermediate region 652, and the inner region 653 in the second region 65. When no air remains between the holder table 21 and the sheet 11, the entire captured image 63 is categorized as the first region 64 being transparent, where no color difference or specific pattern appears; therefore, the determining unit 52 may determine that no air remains between the entire sheet 11 and the holder table 21.

In the determining step, when the determining unit 52 determines that the air (air bubble) remains between the holder table 21 and the sheet 11, the controller 50 controls the protective member forming apparatus 20 to perform predetermined countermeasure process(es) so that the protective member 10 may not be formed with the air remaining between the sheet 11 and the holder table 21. Optionally, the countermeasure process(es) described below may be performed independently or in combination.

### Countermeasure Process: Sheet Reposition-Holding Step

For example, as a countermeasure process, a sheet reposition-holding step may be performed. In the sheet reposition-holding step, the controller 50 may control the sheet feeder assembly 30 to temporarily remove the sheet 11, which is determined have the air remaining there-underneath, from the holder table 21, and operate the sheet conveyer arm 32 and the sheet pressing roller 34 to cause the holder table 21 to hold the sheet 11 once again (reposition). Thereafter, the image-capturing step and the determining step may be repeated. In a case where the air remaining between the holder table 21 and the sheet 11 was not caused by dust adhered to the lower surface of the sheet 11 or the holder surface 22 of the holder table 21, the air may be removed by such a repositioning operation.

For repositioning of the sheet 11, the sheet feeder assembly 30 may be controlled such that the sheet gripper device 323 grips the sheet 11 continuously during the image-capturing step and the determining step so that the sheet conveyer arm 32 may reposition the sheet 11 promptly. In the state where the sheet gripper device 323 grips the end of the sheet 11, a part of the sheet 11 in the vicinity of the gripped end may float from the holder surface 22; therefore, the controlling program may be arranged such that the determining unit 52 may not determine the air remains between the sheet 11 and the holder table 21 based on the difference in the color tones or the brightnesses at the gripped end of the sheet 11 in the captured image.

In the case where the air remainder was caused by dust adhering to the lower surface of the sheet 11 or the holder surface 22 of the holder table 21, the air may once again remain between the sheet 11 and the holder table 21 even after the sheet 11 is repositioned on the holder table 21. If the situation where the air remains is not cleared even after repeating the image-capturing step, the determining step, and the sheet reposition-holding step for a predetermined number of times, the controller 50 may discard the sheet 11 and control the sheet feeder assembly 30 to repeat the sheet-feeding step and the sheet-holding step with a new sheet 11 to have the new sheet 11 held on the holder table 21.

### Countermeasure Process: Dust-Removing Step

In the case where the air remainder was caused by dust adhering to the holder surface 22 of the holder table 21, the air remainder may not be cleared even after the new sheet 11 is fed to and held on the holder table 21 having the dust thereon. In such a case, the controller 50 may perform a dust-removing step for removing the dust from the holder table 21.

For example, for removing dust from the holder table 21 in the dust-removing step, the protective member forming apparatus 20 may be equipped with a foreign-matter removable assembly that may remove a foreign matter from the holder table 21. When the determining unit 52 determines that the air remains between the holder table 21 and the sheet 11 in the determining step, the controller 50 may operate the sheet feeder assembly 30 to remove the sheet 11 from the holder table 21 and operate the foreign-matter removable assembly to clean the holder surface 22. The foreign-matter removable assembly may be composed of, for example, an air blower that may blow high-pressure air to blow the foreign matter away from the holder table 21 or a cleaning brush that may contact the holder surface 22 and move in the horizontal direction. By removing the dust, which may otherwise cause the air to remain between the sheet 11 and the holder table 21, recurrence of the air remainder may be prevented effectively.

### Countermeasure Process: Notifying Step

For another example of the countermeasure process in the case where the determining unit 52 determines that the air remains between the holder table 21 and the sheet 11 in the determining step, a notifying step, for notifying an operator who operates the protective member forming apparatus 20 of the circumstance, may be performed. In the notifying step, a notifying unit may notify the operator of the information that the air remains between the holder table 21 and the sheet 11. As shown in FIG. 1, the protective member forming apparatus 20 has a display 70, a lamp 71, and a speaker 72 as the notifying unit. The display 70 may display various types of information related to the protective member forming apparatus 20. In the notifying step, the controller 50 may operate the display 70 to display information indicating that the air remains between the holder table 21 and the sheet 11 in, for example, text or an icon. The lamp 71 may emit light in a plurality of different colors and may switch an illuminating mode among, for example, continuous illumination and blinking. In the notifying step, the controller 50 may operate the lamp 71 to illuminate in a specific color and a specific illuminating mode. Moreover, in the notifying step, the controller 50 may operate the speaker 72 to generate an audio message or alerting sound to notify the operator of the situation. Optionally, solely one of the display 70, the lamp 71, and the speaker 72 may be used to notify the operator, or two or more of the display 70, the lamp 71, and the speaker 72 may be used in combination to notify the operator. Furthermore, the notifying unit to be used in the notifying step may not necessarily be installed in the protective member forming apparatus 20. For example, the notifying unit may be installed in an external electric device (personal computer, tablet-typed electric terminal) that may communicate with the protective member forming apparatus 20.

The operator notified of the situation by the notifying unit may check the status of the protective member forming apparatus 20 and operate the protective member forming apparatus 20 to perform an action according to the cause of the air remainder. For example, in the case where dust adheres to the holder table 21 or the sheet 11, the operator may command the foreign-matter removable assembly in the protective member forming apparatus 20 to perform the dust-removing step to remove the dust. For another example, in a case where the air remains between the sheet 11 and the holder table 21 but no dust adheres to the holder table 21 or the sheet 11, the operator may operate the protective member forming apparatus 20 to perform the sheet reposition-holding step. Moreover, if the air remainder between the sheet 11 and the holder table 21 is not cleared even after the action corresponding to the dust-removing step or the sheet reposition-holding step, the operator may perform a maintenance operation such as replacing the holder table 21 with another. As such, in the case where the determining unit 52 determines that the air remains, by notifying the operator of the situation, the operator may act appropriately to solve the problem.

Optionally, in the case where the determining unit 52 determines that the air remains between the holder table 21 and the sheet 11, the controller 50 may control the protective member forming apparatus 20 to perform the sheet reposition-holding step and the dust-removing step automatically, while the notifying unit notifies the operator of the information concerning the air remainder. In this case, the operator notified of the problem may check whether the situation with the air remainder is cleared by the sheet reposition-holding step and the dust-removing step.

Through the determination by the determining unit 52 and the countermeasure process based on the determination, the operation to feed the sheet 11 to the holder table 21 in the state where no air remains between the holder table 21 and the sheet 11 may be completed. According to the determination by the determining unit 52 that no air remains between the holder table 21 and the sheet 11 based on the image captured by the camera 47, the need for the countermeasure process is cleared. In the case where the determining step is performed while the sheet gripper device 323 is continuously gripping the sheet 11, the sheet gripper device 323 may release the sheet 11 at the end of the determining step. If the determining unit 52 determines that no air remains between the holder table 21 and the sheet 11 in the determining step, the operation proceeds to a protective member forming step, in which the sheet 11 is attached to the wafer W to form the protective member 10. The protective member forming step includes an expanding step and a curing step.

### Wafer-Holding Step

Before the protective member forming step, a wafer-holding step, in which the wafer W is held on the wafer holder table 40, is performed. Optionally, the wafer-holding step may be performed at least partly in parallel (simultaneously) with at least one of the sheet-feeding step, the sheet-holding step, the image-capturing step, or the determining step. For example, as shown in FIG. 2, in the stage corresponding to the image-capturing step and the determining step, the wafer W may already be held on the wafer holder table 40.

In the wafer-holding step, the wafer W, on which the protective member 10 is not yet formed, is picked out from the cassette 24 in the cassette storage 23 by the first conveyer assembly 27. On the temporary placement table 25, an orientation and a center of the wafer W are detected by the wafer detector device 251. After the wafer detector device 251 detects the orientation and the center of the wafer W, the second conveyer assembly 29 conveys the wafer W to the wafer holder table 40. On the wafer holder table 40, the suction source 45 is driven, and the upper surface Wa of the wafer W is suctioned and held against the wafer holder surface 441 of the suction sheet 44.

### Protective Member Forming Step: Expanding Step

As the sheet 11 is held on the holder table 21 in the state where no air remains between the holder table 21 and the sheet 11, and the wafer W is held on the wafer holder table 40, the operation proceeds to the expanding step as shown in FIGS. 4 and 5. In the expanding step, as shown in FIG. 4, the liquid resin 12 is fed to a gap between the sheet 11 and the wafer W. In particular, the conveyer arm driving assembly 33 is operated to adjust the position of the sheet conveyer arm 32 in the X-axis direction, and the liquid resin feeder nozzle 39 is located above the sheet 11 which has been on the holder surface 22 of the holder table 21 since the sheet-holding step performed earlier. At this stage, the lower nozzle 391 of the liquid resin feeder nozzle 39 is oriented toward the upper surface of the sheet 11, and the upper nozzle 392 is oriented toward the lower surface Wb of the wafer W.

Next, the controller 50 controls the dispenser 38 and load the liquid resin feeder nozzle 39 with the liquid resin 12 from the tank 37. The liquid resin feeder assembly 36 may operate the liquid resin feeder nozzle 39 to feed the liquid resin 12 through the lower nozzle 391 and feed the liquid resin 12 through the upper nozzle 392 independently. The liquid resin 12 is discharged to drip down from the lower nozzle 391 of the liquid resin feeder nozzle 39 to the sheet 11 located below. The lower nozzle 391 is located above a central area of the holder table 21, and the liquid resin 12 dripping down from the lower nozzle 391 may stay in the central area on the upper surface of the sheet 11 within a range smaller than an area of the wafer W. The liquid resin 12 fed through the upper nozzle 392 may stay in a form of a dorm. As the lift/lower assembly 41 is operated to move the wafer W closer to the liquid resin feeder nozzle 39, the liquid resin 12 forming the dorm at the position of the upper nozzle 392 adheres to the lower surface Wb of the wafer W. Optionally, the liquid resin 12 may not be fed to the lower surface Wb of the wafer W through the upper nozzle 392 but may be merely dripped down from the lower nozzle 391 to the sheet 11.

The controller 50 controls an amount of the liquid resin 12 to be fed to the sheet 11 and the lower surface Wb of the wafer W such that the liquid resin 12 may be sufficiently delivered to the entire lower surface Wb of the wafer W based on information of, for example, a size of the wafer W. When a predetermined amount of the liquid resin 12 is fed to the sheet 11 and the lower surface Wb of the wafer W, the conveyer arm driving assembly 33 is operated to move the sheet conveyer arm 32 toward the +X direction side to withdraw from the position between the holder table 21 and the wafer holder table 40.

Next, as shown in FIG. 5, the liquid resin 12 is pressed and spread between the sheet 11 and the wafer W. In particular, the lift/lower assembly 41 is operated to lower the wafer holder table 40 at a predetermined speed. As the wafer holder table 40 descends, the lower surface Wb of the wafer W approaches the holder table 21 and contacts the liquid resin 12 on the sheet 11. Accordingly, the liquid resin 12 is pressed by the lower surface Wb of the wafer W toward the sheet 11 and is spread in the radial direction of the wafer W.

As the wafer holder table 40 is lowered and the liquid resin 12 is spread by the lower surface Wb of the wafer W, a load in the Z-axis direction (vertical direction) applied to the lower surface Wb of the wafer W increases. When the liquid resin 12 spreads over the entire lower surface Wb of the wafer W and further outward beyond the outer edge of the wafer W, as shown in FIG. 5, the load may start decreasing. Such a change of the intensity in the load is detected by the load sensor 46. As such, based on the detection result, the controller 50 may detect the liquid resin 12 being in a state spread over the entire lower surface Wb of the wafer W. When the controller 50 detects this state, the controller 50 operates the wafer holder table 40 to stop descending, and the expanding step is completed thereat.

Alternatively, a distance between the holder table 21 and the wafer holder table 40 may be set in advance, and the expanding step may be completed by the wafer holder table 40 being lowered by the distance.

### Protective Member Forming Step: Curing Step

As the expanding step is completed, and as the lower surface Wb of the wafer W is entirely covered with the liquid resin 12, the operation proceeds to the curing step. As shown in FIG. 6, in the curing step, under the control of the controller 50, the wafer holder table 40 is operated to stop suctioning or holding the upper surface Wa of the wafer W against the wafer holder surface 441 (the suctioning source 45 operated to stop generating the negative pressure) and release the wafer W, and the lift/lower assembly 41 is operated to lift the wafer holder table 40 upward. Next, the light 28 is operated to emit the ultraviolet rays UV of the intensity that may cure the liquid resin 12 at the holder surface 22. The ultraviolet rays UV emitted from the light 28 may pass through the holder plate 211 and the sheet 11 with transparency to reach the liquid resin 12 and cure the liquid resin 12, which is the UV-curable resin. The controller 50 may determine a curing status of the liquid resin 12 based on, for example, passing of a predetermined length of time or an analysis of an image of the liquid resin 12 captured by the camera 47. When the controller 50 determines that the liquid resin 12 cured sufficiently, the controller 50 stops emitting the ultraviolet rays UV from the light 28. As a result, the sheet 11 is attached to the wafer W through the resin 13, which is the cured liquid resin 12, and the protective member 10 composed of the sheet 11 and the cured resin 13 is formed.

As described above, through the protective member forming step, including the expanding step, in which the liquid resin 12 fed to the position between the sheet 11 and the wafer W is spread over the entire surface on one side of the wafer W, and the curing step, in which the liquid resin 12 expanded in the expanding step is cured, the sheet 11 is attached to the wafer W through the cured resin 13.

### Post-Processing Step

After forming the protective member 10, a post-processing step is performed under the control of the controller 50. In the post-processing step, the wafer W on which the protective member 10 is formed is passed from the wafer holder table 40 to the robot hand 294 of the second conveyer assembly 29 and conveyed by the second conveyer assembly 29 to the sheet cutting table 26. The wafer W is held on the sheet cutting table 26, and an excessive outer peripheral part of the sheet 11 protruding outward from the wafer W is cut off with the sheet cutter 261. Next, the first conveyer assembly 27 is operated to store the wafer W in the cassette 24 in the cassette storage 23. Thereby, a serios of operation in the protective member forming apparatus 20 with the wafer W is completed.

As descried above, in the protective member forming apparatus 20, the sheet 11 held on the holder table 21 is irradiated by the light 28 (or a light located at a position different from the light 28), the image of the sheet 11 is captured by the camera 47 from the position in the oblique direction, and the determining unit 52 determines whether the air remains between the holder table 21 and the sheet 11 by the criterion based on the difference between the color tones, the brightnesses, or the colors in the image captured by the camera 47. In the case where the determining unit 52 determines that no air remains, the liquid resin 12 is fed to the position between the sheet 11 and the wafer W, the liquid resin 12 is spread and cured, and the sheet 11 is attached to the wafer W, to form the protective member 10. On the other hand, in the case where the determining unit 52 determines that the air remains between the sheet 11 and the holder table 21, the notifying unit (e.g., the display 70, the lamp 71, and the speaker 72) notifies the operator of the situation. As such, the liquid resin 12 may be fed to the sheet 11 after confirming that no air remains between the holder table 21 and the sheet 11. Accordingly, the protective member 10 formed in the protective member forming apparatus 20 may not have thickness unevenness that may otherwise be caused by the air remining between the holder table 21 and the sheet 11 but may be formed throughout in an even thickness.

The determining unit 52 may determine whether or not the air remains between the holder table 21 and the sheet 11 based on the image of the sheet 11 captured by the camera 47; therefore, without a need for adding a specific sensor or a device other than the camera 47, an installation cost may be lowered. Moreover, by the camera 47 that may capture the image of the sheet 11 from the position in the oblique direction, the image of the entire sheet 11 (at least including the region at which the sheet 11 is attached to the wafer W) may be obtained. Therefore, a time required to determine whether the air remains may be shortened, and the protective member forming apparatus 20 may form the protective member 10 efficiently.

The wafer W, on which the protective member 10 is formed, is conveyed to the grinding apparatus, which is not shown. In the grinding apparatus, the wafer W is placed on the holder surface of the chuck table with the side of the protective member 10 facing downward, and the upper surface Wa of the wafer W is ground with a grindstone. As described above, the protective member 10 is formed in the protective member forming apparatus 20, in the state on the holder table 21 where no air remains underneath the sheet 11, in the even thickness entirely. Therefore, lowering the accuracy of grinding the wafer W due to the uneven thickness of the protective member 10 may be avoided, and the in-plane thickness of the wafer W ground to a desired thickness may be even. In other words, a wafer W in an even thickness may be manufactured by grinding.

Optionally, arrangement and/or configuration of the camera to capture an image of the sheet may be different from those in the embodiment described above. For example, the protective member forming apparatus 20 in the embodiment described above has the camera 47 at the single location; however, the protective member forming apparatus may be equipped with a plurality of cameras arranged at a predetermined intervals along a circumferential direction of the holder table 21, and the determining unit may determine whether the air remains between the holder table 21 and the sheet 11 based on the plurality images captured by the plurality of cameras.

As a modified example, a camera may be installed in the inner space 213 in the holder table 21. For example, if the camera is located at a position in the inner space 213 in the vicinity of an inner peripheral surface of the frame member 212 on an outermost edge, the camera may capture an image of a most part of the range, at which the sheet 11 is attached to the wafer W, from an oblique lower position through the holder plate 211 which is translucent. For another example, a camera including an ultrawide-angle lens (fisheye lens) may be provided on the bottom at a radially central position in the inner space 213. In the case where the image of the sheet 11 is captured by the camera with the ultrawide-angle lens located in the central area on the bottom of the inner space 213, with regard to a circumferential area toward the outer circumference of the sheet 11, the image may be captured from a position in an oblique direction with respect to the sheet 11. Therefore, the image, which is usable in the determining step to determine as to whether the air remains or not, may be obtained.

Using the camera 47 that may capture the image of the sheet 11 from the oblique position may have the advantages as described above. On the other hand, even in a case where the image of the sheet 11 is captured by a camera located straight above or a straight sideward from the sheet 11, the difference in color tones, brightness, or colors may still be caused between the region where the air remains and the region where no air remains; therefore, presence or absence of the air between the holder table 21 and the sheet 11 may still be determined. In other words, the camera may not necessarily capture an image of the sheet 11 from the position in the oblique direction. In the case where the camera captures an image of the sheet 11 from the straight above position, for example, the camera may be supported movably in the horizontal direction and may be located at the position straight above the holder table 21 to capture the image of the sheet 11, and after capturing the image, the camera may be withdrawn to a position outside of the holder table 21.

Embodiment of the present disclosure may not necessarily be limited to the configurations described above or in the modified example but may be modified, substituted, or altered in various ways without departing from the spirit of the technical idea of the present disclosure. Furthermore, if the technical idea of the present disclosure may be realized in a different way due to technological progress or other derived technology, it may be implemented with use of the method. Therefore, the claims cover all embodiments that may be included within the scope of the technical idea of the present disclosure.

As described above, according to the protective member forming apparatus and the method for forming the protective member in the present disclosure, by confirming that no air remains between the holder table and the sheet, the protective member in the even thickness where no air remainder is left between the holder table and the sheet may be formed, thereby improving accuracy of a process such as a grinding process with a wafer, on which the protective member is formed.

1. A protective member forming apparatus, comprising:
a holder table configured to hold a sheet on a holder surface;
a sheet feeder assembly configured to feed the holder table with the sheet;
an attaching assembly configured to attach the sheet held on the holder table to a wafer;
a light configured to irradiate the sheet held on the holder table;
a camera configured to capture an image of the sheet; and
a determining unit configured to determine whether air remains between the holder table and the sheet or not based on a difference in color tones, brightnesses, or colors in the image captured by the camera.

2. A method for forming a protective member on one side of the wafer with the protective member forming apparatus according to claim 1, comprising:
a sheet-holding, including causing the sheet to be held on the holder table;
an image-capturing, including capturing the image of the sheet by the camera; and
determining whether the air remains between the holder table and the sheet or not based on the difference in the color tones, the brightnesses, or the colors in the image captured during the image-capturing,
wherein the method further comprises, in a case where it is determined that the air remains between the holder table and the sheet during the determining, notifying an operator of the air remaining between the holder table and the sheet, and
wherein the method further comprises, in a case where it is determined that no air remains between the holder table and the sheet during the determining, a protective member forming, including forming of the protective member for protecting the one side of the wafer by attaching the sheet to the wafer.

3. The method according to claim 2,
wherein the protective member forming includes:
an expanding, including feeding a liquid resin to a position between the sheet and the wafer and expanding the liquid resin over an entire surface of the wafer on the one side; and
curing the liquid resin expanded during the expanding, and
wherein the sheet is attached to the wafer through a resin which is the liquid resin being cured.
